(19) United States
(12) Patent Application Publication
(10) Pub. No.: US 2019/0128158 A1
(43) Pub. Date: May 2, 2019

(54) RAMJET GENERATOR FOR INTAKE/EXHAUST PIPE

(71) Applicant: Dong Kyu LEE, Seoul (KR)

(72) Inventor: Dong Kyu LEE, Seoul (KR)

(21) Appl. No.: 16/024,315

(22) Filed: Jun. 29, 2018

(30) Foreign Application Priority Data
Oct. 30, 2017 (KR) 10-2017-0142735

(51) Int. Cl. F01N 1/08; F02B 31/04

(52) U.S. Cl. CPC F01N 1/086; F02B 31/04

(57) ABSTRACT

A ramjet generator for an intake/exhaust pipe of the present invention includes: a central jet having a predetermined length and disposed in the intake/exhaust pipe; and a vortex generator having two or more blades connected to the central jet at sides and extending outwards with a predetermined area, in which the blades have elasticity to come in contact with an inner side of the intake/exhaust pipe of an internal combustion engine and form an external shape of the vortex generator to correspond to a shape of the inner side of the intake/exhaust pipe of the internal combustion engine. According to the present invention, it is possible to improve intake/exhaust efficiency of an internal combustion engine by generating a vortex using a ramjet that increases the flow speed of air in an intake/exhaust pipe connecting an engine and an air cleaner for an internal combustion engine.

### CROSS REFERENCE TO RELATED APPLICATION

The present application claims priority to Korean Patent Application No. 10-2017-0142735, filed Oct. 30, 2017, the entire contents of which is incorporated herein for all purposes by this reference.

### BACKGROUND OF THE INVENTION

### Field of the Invention

The present invention relates to a ramjet generator for an intake/exhaust pipe and, more particularly, to a ramjet generator for an intake/exhaust pipe, the ramjet generator being able to increase the flow speed of air in an intake/exhaust pipe connecting an engine and an air cleaner for an internal combustion engine, to improve intake/exhaust efficiency of the internal combustion engine by generating a vortex by a ramjet, and to be fixed in close contact with the inner side of the intake/exhaust pipe regardless of the type and size of the internal combustion engine.

### Description of the Related Art

The internal combustion engines of vehicles are classified into a gasoline engine and a diesel engine. The gasoline engine mixes fuel and air at an optimum ratio and burns the gas mixture with an electrical flame and the diesel engine increases the power of the engine by spraying fuel to compressed air.

The combustion efficiency, power, and the amount of exhaust gas of both of the gasoline engine and the diesel engine depend on the mixing ratio of air and fuel.

Accordingly, the gasoline engine and the diesel engine can perform stable combustion in a combustion chamber of cylinders only when the mixing ratio of air and fuel is stable to be suitable for the combustion way.

However, in vehicles having high mileage, the engine is decrepit and air is not stably suctioned into the intake system, so air and fuel are mixed at an unstable ratio and inefficient combustion is frequently generated in the combustion chamber. Accordingly, when the engine outputs power, a large amount of exhaust gas is discharged.

The reason that a large amount of noxious gas is discharged is because combustion is generated without the fuel from a spray nozzle stably mixed with air.

In order to solve this problem, there is a method of generating a vortex of air flowing through an air cleaner by installing a vortex generator in an intake pipe, thereby increasing the amount of air supply.

However, according to this vortex generator, only a vortex is generated, that is, the air flowing into an engine through an air cleaner generates torque only while passing by the blades of the vortex generator installed in the intake pipe. Further, the inflow air is accelerated only in a predetermined section in the intake pipe while passing through the vortex generator having a plurality of blades in the cylindrical pipe, and the distance that the air flows is limited by friction on the inner wall of the intake pipe, so there is still difficulty in increasing the amount of air supply and flow speed and optimizing the fuel mixing ratio.

Further, there is no technique for quickly discharging exhaust gas and specific vortex generators are required for the types and sizes of internal combustion engines.

### SUMMARY OF THE INVENTION

In order to solve these problems, an object of the present invention is to provide a ramjet generator for an intake/exhaust pipe, the ramjet generator being able to increase the intake/exhaust efficiency of an internal combustion engine by generating a vortex, using a ramjet that increases the flow speed of air in an intake/exhaust pipe connecting the engine and an air cleaner for an internal combustion engine.

Another object of the present invention is to provide a ramjet generator for an intake/exhaust pipe, the ramjet generator being able to be freely adjusted in length regardless of the types and sizes of internal combustion engines and can be fixed in contact with the inner side of an intake/exhaust pipe.

The objects of the present invention are not limited to those described above and other objects not stated herein would be understood by those who have ordinary skills in the art that the present invention belongs to (hereafter, ‘those skilled in the art’) from the following description.

In order to achieve the objects of the present invention, a ramjet generator for an intake/exhaust pipe includes: a central jet having a predetermined length and disposed in the intake/exhaust pipe; and a vortex generator having a blade connected to the central jet at a side and extending outwards with a predetermined, in which the blade has elasticity to come in contact with an inner side of the intake/exhaust pipe of an internal combustion engine and forms an external shape of the vortex generator to correspond to a shape of the inner side of the intake/exhaust pipe of the internal combustion engine.

The blade may have two or more coupling holes formed through the blade and coupling protrusions formed at the second side of the blade to be inserted in the coupling holes, and the coupling protrusion may be inserted in the coupling hole, so the vortex generator may be brought in contact with the inner side of the intake/exhaust pipe of the internal combustion engine.

An outer side of the vortex generator may be formed by bending the blade.

The size of the outer side of the vortex generator may be changed by changing a position where the coupling protrusion is inserted in the coupling hole.

Two or more blades may be provided, the blades each may have two or more coupling holes formed through the blade and coupling protrusions formed at the second side of the blade to be inserted in the coupling holes, and the vortex generator may be disposed in contact with the inner side of the intake/exhaust pipe with the coupling protrusion of any one blade fitted in the coupling hole of the other blade.

An outer side of the vortex generator may be formed by bending the blade.

The size of the outer side of the vortex generator may be changed by changing a position where the coupling protrusion is inserted in the coupling hole.

The coupling holes may be arranged in pairs in two lines, and the coupling protrusions may be formed in pairs to be inserted into the coupling holes.

An outer side of the vortex generator may be formed by bending the blade.

The size of the outer side of the vortex generator may be changed by changing a position where the coupling protrusion is inserted in the coupling hole.

The ramjet generator may further include locking members in which the coupling protrusions are inserted and fixed, and the locking protrusions each may have a plurality of locking steps such that the locking steps are fixed to the locking members.

The size of the outer side of the vortex generator may be changed in accordance with positions where the coupling protrusions are inserted in the coupling holes and positions where the locking steps are fixed to the locking members, so the outer side of the vortex generator may come in contact with the inner side of the intake/exhaust pipe.

According to the present invention, it is possible to improve intake/exhaust efficiency of an internal combustion engine by generating a vortex using a ramjet that increases the flow speed of air in an intake/exhaust pipe connecting an engine and an air cleaner for an internal combustion engine.

Further, the lengths of the blades can be freely adjusted regardless of the types and sizes of internal combustion engines, so the ramjet generator can be fixed with the outer side in close contact with the inner side of an intake/exhaust pipe.

Further, installation and separation are simple, so it has an advantage in terms of maintenance.

Effects of the present invention are not limited to those described above and other effects can be clearly recognized by those skilled in the art from the following description.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view of a ramjet generator according to an exemplary embodiment of the present disclosure;

FIG. 2 is a front view showing the state before blades shown in FIG. 1 are combined;

FIG. 3 is a front view showing the state after the blades shown in FIG. 1 are combined;

FIG. 4 is a view when the ramjet generator shown in FIG. 1 is installed and ramjet vortexes are generated in an intake/exhaust pipe;

FIGS. 5A and 5B are views showing a coupling structure of a ramjet generator according to another embodiment of the present invention;

FIG. 6 is a view showing a coupling structure of a ramjet generator according to another embodiment of the present invention;

FIG. 7 is a front view showing a blade of a ramjet generator according to another embodiment of the present invention;

FIG. 8 is a view showing a coupling state of FIG. 7;

FIG. 9 is a view showing a ramjet generator having five blades in accordance with the present invention; and

FIG. 10 is a view showing a ramjet generator having eight blades in accordance with the present invention.

### DETAILED DESCRIPTION OF THE INVENTION

A ramjet generator according to the present invention is described hereafter in detail with the drawings.

In the following description of the present invention, detailed descriptions of well-known functions or configurations relating to the present invention will not be provided so as not to obscure the description of the present invention with unnecessary details.

The terms to be described below are set in consideration of functions in the present invention and may be changed in accordance with the intention or usage of manufacturers, so the definition should be based on the entire specification.

The present invention is described logically hereafter with reference to the drawings.

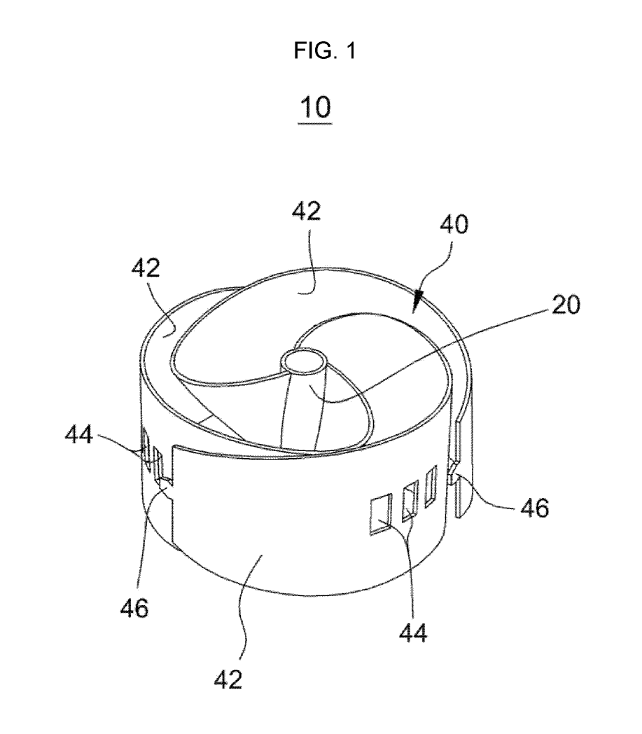

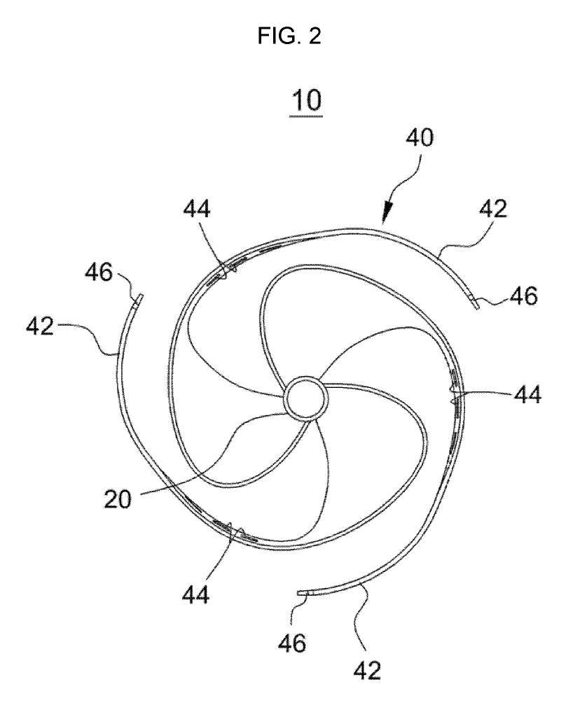

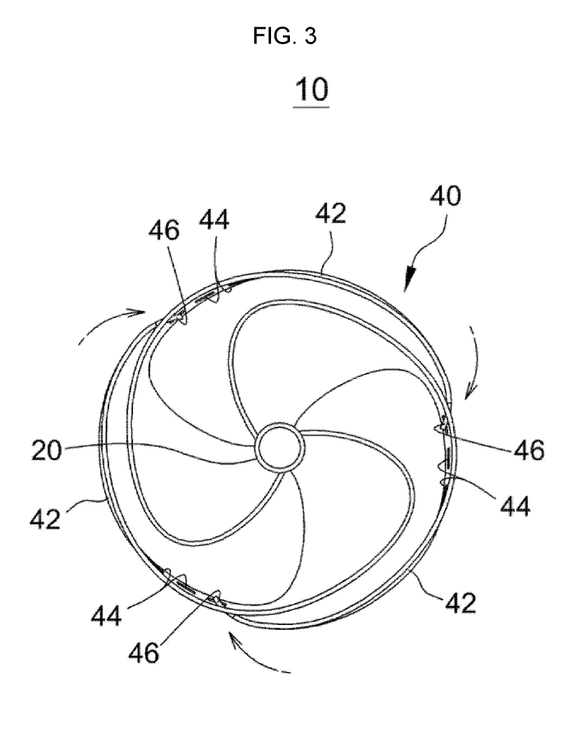

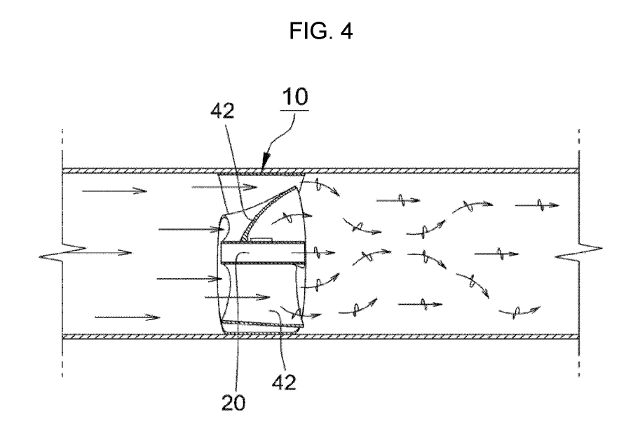

FIG. 1 is a perspective view of a ramjet generator according to an exemplary embodiment of the present disclosure, FIG. 2 is a front view showing the state before blades shown in FIG. 1 are combined, FIG. 3 is a front view showing the state after the blades shown in FIG. 1 are combined, and FIG. 4 is a view when the ramjet generator shown in FIG. 1 is installed and ramjet vortexes are generated in an intake/exhaust pipe.

Referring to FIGS. 1 to 4, a ramjet generator for an intake/exhaust pipe (hereafter, referred to as a ramjet generator) 10 according to the present invention includes a central jet 20 and a vortex generator 40.

The central jet 20 has a predetermined length and is disposed in an intake/exhaust pipe and may be formed in a cylindrical shape.

The vortex generator 40 has two or more blades 42 connected to the central jet 20 at sides and extending outwards with a predetermined area.

The blades 42 have elasticity to come in contact with the inner side of an intake/exhaust pipe of an internal combustion engine and form the external shape of the vortex generator 40 to correspond to the shape of the inner side of the intake/exhaust pipe of an internal combustion engine.

In detail, the blades 42 are made of synthetic resin or metal that has elasticity, so they can have elasticity to correspond to the inner side of an intake/exhaust pipe and can be fixed in contact with the inner side of an intake/exhaust pipe.

The blades 42 each may have a coupling hole 44 and a coupling protrusion 46, so the vortex generator 40 can be disposed in contact with the inner side of an intake/exhaust pipe with the coupling protrusion 46 of any one blade 42 fitted in the coupling hole 44 of the other blade 42.

Two or more coupling holes 44 may be formed through the blades 42 and may have a rectangular shape, as shown in the figures, but the shape is not limited thereto.

The coupling protrusions 46 are formed at the second sides of the blades 42 and can be inserted in the coupling holes 44, whereby the external shape of the vortex generator 40 may be formed.

The second sides of the blades 42 means the sides opposite to the ends connected to the central jet 20, that is, the coupling protrusions 46 are formed at the second ends of the blades 42 and can be inserted in the coupling hole 44.

The blades 42 can be elastically bent and the outer side of the vortex generator 40 can be formed by bending the blades 42.

The outer side of the vortex generator 40 may have a constant curvature or may have different curvatures at predetermined sections.

That is, the outer side of the vortex generator 40 formed by bending the blades 42 may include various circles and may be construed as including an entirely circular shape even if the outer side is partially curved by the coupling holes 44 and the coupling protrusions 46 of the blades 42.

The size of the outer side of the vortex generator 40 may depend on the positions where the coupling protrusions 46 are inserted in the coupling holes 44.

That is, the blades 42 of the vortex generator 40 are wound around the central jet 20. The blades 42 are coupled to each other while partially overlapping each other by fitting the coupling protrusions 46 in the coupling holes 44, whereby one cylindrical vortex generator 40 can be formed.

The outer diameter of the vortex generator 40 can be freely adjusted in accordance with the positions where the coupling protrusions 46 are fitted in the coupling holes 44. Accordingly, the ramjet generator 10 can be disposed in intake/exhaust pipes of various internal combustion engines by freely adjusting the diameter of the vortex generator 40 regardless of the types and sizes of the internal combustion engines.

Further, when the blades 42 of the vortex generator 40 of the ramjet generator 10 are coupled to each other, the ramjet generator 10 can be fixed in close contact with the inner side of an intake/exhaust pipe by the outwardly acting elasticity of the blades 42.

Referring to FIG. 4, when air is suctioned or discharged with the ramjet generator 10 disposed in an intake/exhaust pipe, the air rotates along the inner sides of the blades 42 of the vortex generator 30, so vortexes are generated in the intake/exhaust pipe.

Further, the air flowing straight through the cylindrical central jet 20 is rotated and quickly suctioned by the suction force generated by rotation of the vortex generator 40, so a ramjet is generated by interaction of the vortex generator 40 and the central jet 20, whereby air can be quickly suctioned and discharged.

Since the ramjet generator can be freely installed in intake/exhaust pipes having different sizes regardless of the types and sizes of internal combustion engines, that is, one ramjet generator 10 can be applied to intake/exhaust pipes having various sizes, compatibility is high.

Further, installation of the ramjet generator is performed by winding and coupling the blades 42, thus the ramjet generator can be conveniently installed by anyone.

Further, users may selectively install a plurality of ramjet generator 10 in an intake/exhaust pipe, so users can selectively control the mount of intake/exhaust gas.

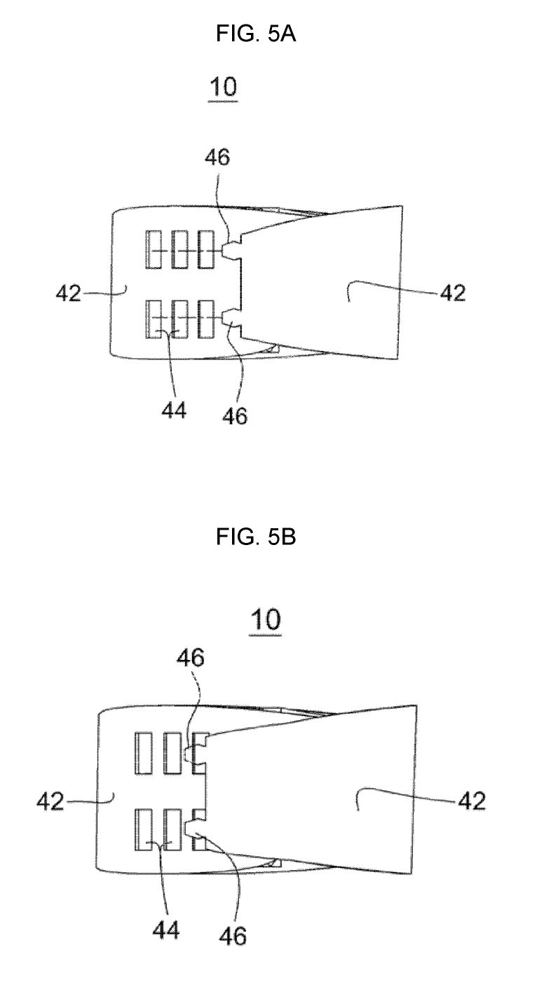

FIGS. 5A and 5B are views showing a coupling structure of a ramjet generator according to another embodiment, in which configuration and operation relationship that are the same as those described with reference to FIGS. 1 to 4 are not described here.

The coupling holes 44 of the blades 42 of the vortex generator 40 may be formed in pairs in two lines and the coupling protrusions 46 may also be formed in pairs to be able to be inserted in the coupling holes 44.

A user can adjust the coupling strength by selectively one of coupling protrusions 46 inserted in a coupling hole 44 and exposing the other coupling protrusion 46 to the outside when winding each of the blades 42 of the vortex generator 40.

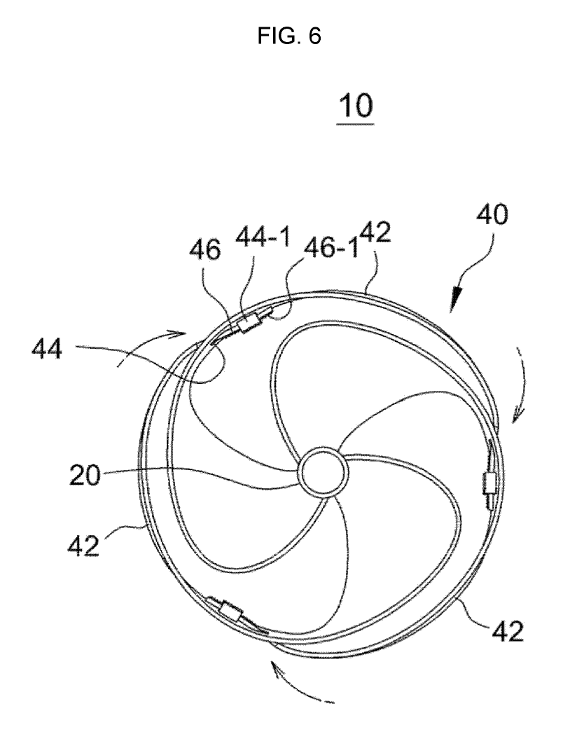

FIG. 6 is a view showing a coupling structure of a ramjet generator according to another embodiment, in which configuration and operation relationship that are the same as those described with reference to FIGS. 1 to 4 are not described here.

According to this embodiment, the blades 42 each further have a locking member 44-1 in which a coupling protrusion 46 is inserted and fixed and the protrusions 46 each have a plurality of locking steps 46-1, so the locking steps 46-1 can be fixed to the locking members 44-1.

That is, by fixing the locking steps 46-1 to the locking member 44-1, predetermined external shapes can be given to the vortex generator 40 with the blades 42 fixed not in contact with the inner side of an intake/exhaust pipe.

Further, the size of the outer side of the vortex generator can be changed in accordance with the positions where the coupling protrusions 46 are inserted in the coupling holes 44 and the positions where the locking steps 46-1 are fixed to the locking members 44-1, so the outer side of the vortex generator 40 may come in contact with the inner side of an intake/exhaust pipe.

In order to determine the external shape of the vortex generator 40, when the blades 42 are wound, the coupling protrusions 46 are inserted into the coupling holes 44 and into the coupling members 44-1 such that the locking steps 46-1 of the coupling protrusions 46 are locked to the locking members 44-1, so the lengths of inserting and fixing the coupling protrusions 46 can be adjusted in this way.

Accordingly, a user can finely adjust the insertion lengths of the locking protrusions 46, so it is possible to more precisely install and fix the ramjet generator 10 in an intake/exhaust pipe.

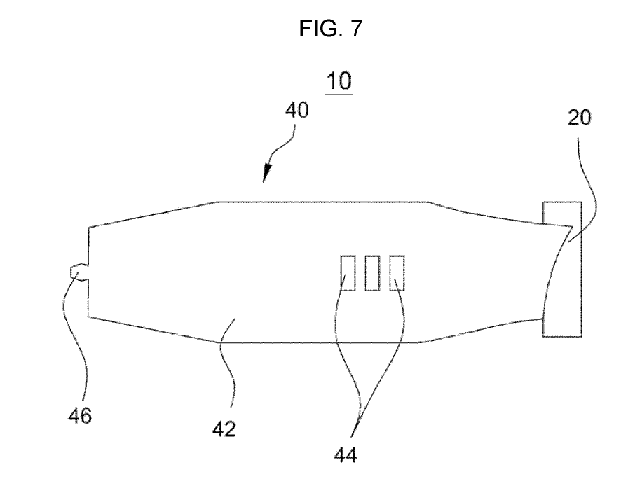

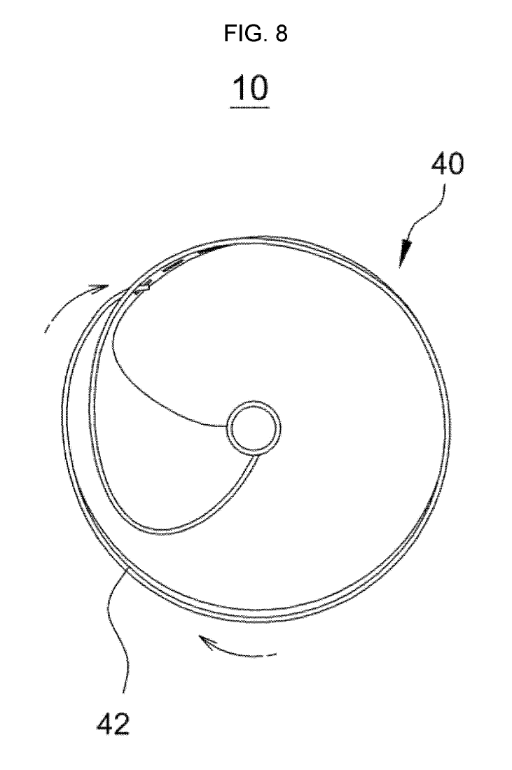

FIG. 7 is a front view showing a blade of a ramjet generator according to another embodiment of the present invention and FIG. 8 is a view showing a coupling state of the ramjet generator of FIG. 7.

Configuration and operation relationship in this embodiment that are the same as those described with reference to FIGS. 1 to 4 are not described here.

The vortex generator 40 according to this embodiment may have one wound blade 42.

Accordingly, a user can freely select the number of blades 42 in accordance with the types and sizes of internal combustion engines.

That is, a user can selectively install a ramjet generator in accordance with the sizes of intake/exhaust pipes that depend on the types and sizes or capacities of internal combustion engines, that is, when the size of an intake/exhaust pipe is small, a user can select and install a ramjet generator having one blade.

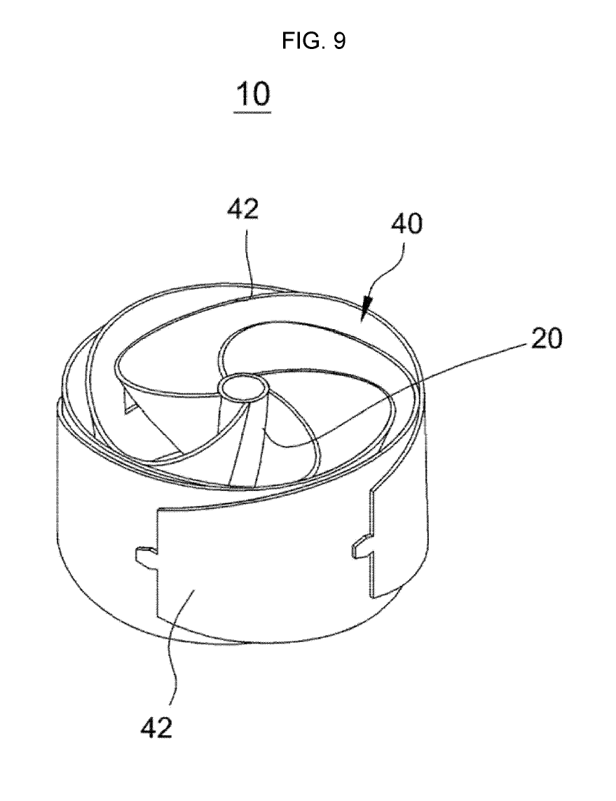

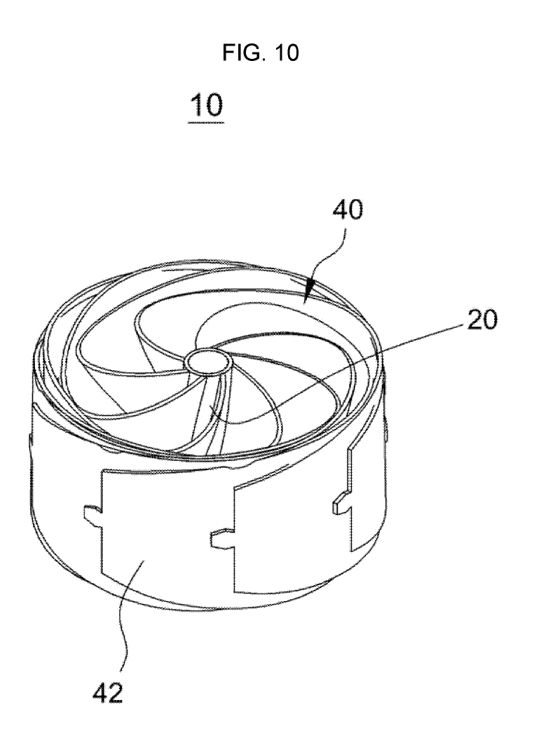

FIG. 9 is a view showing a ramjet generator having five blades in accordance with the present invention and FIG. 10 is a view showing a ramjet generator having eight blades in accordance with the present invention.

Configuration and operation relationship in this embodiment that are the same as those described with reference to FIGS. 1 to 4 are not described here.

The vortex generator 40 according to this embodiment may have a plurality of wound blade 42.

That is, a user can selectively install a ramjet generator in accordance with the sizes of intake/exhaust pipes that depend on the types and sizes or capacities of internal combustion engines, that is, when the size of an intake/exhaust pipe is large, a user can select and install a ramjet generator having a plurality of blades.

Embodiments for achieving a ramjet generator for an intake/exhaust pipe of the present invention were described above only as examples, and the present invention is not limited to the embodiments and may be changed in various ways by those skilled in the art without departing from the spirit of the present invention.

What is claimed is:

1. A ramjet generator for an intake/exhaust pipe, the ramjet generator comprising:
a central jet having a predetermined length and disposed in the intake/exhaust pipe; and
a vortex generator having a blade connected to the central jet at a side and extending outwards with a predetermined area,
wherein the blade has elasticity to come in contact with an inner side of the intake/exhaust pipe of an internal combustion engine and forms an external shape of the vortex generator to correspond to a shape of the inner side of the intake/exhaust pipe of the internal combustion engine.

2. The ramjet generator of claim 1, wherein the blade has two or more coupling holes formed through the blade and coupling protrusions formed at the second side of the blade to be inserted in the coupling holes, and
the coupling protrusion is inserted in the coupling hole, so the vortex generator is brought in contact with the inner side of the intake/exhaust pipe of the internal combustion engine.

3. The ramjet generator of claim 2, wherein an outer side of the vortex generator is formed by bending the blade.

4. The ramjet generator of claim 3, wherein the size of the outer side of the vortex generator is changed by changing a position where the coupling protrusion is inserted in the coupling hole.

5. The ramjet generator of claim 1, wherein two or more blades are provided,
the blades each have two or more coupling holes formed through the blade and coupling protrusions formed at the second side of the blade to be inserted in the coupling holes, and
the vortex generator is disposed in contact with the inner side of the intake/exhaust pipe with the coupling protrusion of any one blade fitted in the coupling hole of the other blade.

6. The ramjet generator of claim 5, wherein an outer side of the vortex generator is formed by bending the blade.

7. The ramjet generator of claim 6, wherein the size of the outer side of the vortex generator is changed by changing a position where the coupling protrusion is inserted in the coupling hole.

8. The ramjet generator of claim 5, wherein the coupling holes are arranged in pairs in two lines, and
the coupling protrusions are formed in pairs to be inserted into the coupling holes.

9. The ramjet generator of claim 8, wherein an outer side of the vortex generator is formed by bending the blade.

10. The ramjet generator of claim 9, wherein the size of the outer side of the vortex generator is changed by changing a position where the coupling protrusion is inserted in the coupling hole.

11. The ramjet generator of claim 3, further comprising locking members in which the coupling protrusions is inserted and fixed, and
the locking protrusions each have a plurality of locking steps such that the locking steps are fixed to the locking members.

12. The ramjet generator of claim 6, further comprising locking members in which the coupling protrusions is inserted and fixed, and
the locking protrusions each have a plurality of locking steps such that the locking steps are fixed to the locking members.

13. The ramjet generator of claim 9, further comprising locking members in which the coupling protrusions is inserted and fixed, and
the locking protrusions each have a plurality of locking steps such that the locking steps are fixed to the locking members.

14. The ramjet generator of claim 11, wherein the size of the outer side of the vortex generator is changed in accordance with positions where the coupling protrusions are inserted in the coupling holes and positions where the locking steps are fixed to the locking members, so the outer side of the vortex generator comes in contact with the inner side of the intake/exhaust pipe.

15. The ramjet generator of claim 12, wherein the size of the outer side of the vortex generator is changed in accordance with positions where the coupling protrusions are inserted in the coupling holes and positions where the locking steps are fixed to the locking members, so the outer side of the vortex generator comes in contact with the inner side of the intake/exhaust pipe.

16. The ramjet generator of claim 13, wherein the size of the outer side of the vortex generator is changed in accordance with positions where the coupling protrusions are inserted in the coupling holes and positions where the locking steps are fixed to the locking members, so the outer side of the vortex generator comes in contact with the inner side of the intake/exhaust pipe.
